(19) United States
(12) Patent Application Publication
(10) Pub. No.: US 2023/0334722 A1
(43) Pub. Date: Oct. 19, 2023

(54) VIDEO PROCESSING SYSTEM

(71) Applicant: PRETIA TECHNOLOGIES, INC., Tokyo (JP)

(72) Inventors: Yu USHIO, Tokyo (JP); KunChun TSAI, Tokyo (JP)

(21) Appl. No.: 18/000,431

(22) PCT Filed: Apr. 28, 2021
(86) PCT No.: PCT/JP2021/017088

§ 371 Date: Dec. 1, 2022

(30) Foreign Application Priority Data
Jun. 9, 2020 (JP) 2020-099792

(51) Int. Cl. G06T 11/00; G06V 20/20

(52) U.S. Cl. CPC G06T 11/00; G06V 20/20

(57) ABSTRACT

A video processing system capable of improving interest of a user includes a plurality of user terminals each configured to generate first space data based on the video of the real space acquired in real time; and a server to be accessed by the plurality of user terminals, which is configured to store second space data generated based on an image of the real space acquired in advance. The video processing system is configured to execute: a positional information acquisition step of acquiring positional information on the plurality of user terminals in the real space by comparing the first space data and the second space data to each other; and an augmented reality space generation step of generating the augmented reality space by arranging a virtual object in the video of the real space acquired in real time based on the positional information acquired in the positional information acquisition step.

### TECHNICAL FIELD

The present invention relates to a video processing system, and more particularly, to a video processing system for generating an augmented reality space based on a video of a real space.

### BACKGROUND ART

In recent years, there has been proposed a video processing technology for providing an augmented reality space exhibiting an extension of a real space, in which a video formed of computer graphics is superimposed on a video of a real space perceptible to a user, to thereby allow the user to enjoy harmony between the real space and the video.

In Patent Literature 1, there is disclosed a video processing device for rendering, in an augmented reality space in which a plurality of virtual objects generated based on a plurality of markers acquired by a camera are arranged, an interaction that occurs between those virtual objects depending on a degree of proximity between the plurality of virtual objects.

### CITATION LIST

### Patent Literature

[PTL 1] JP 2016-131031 A

### SUMMARY OF INVENTION

### Technical Problem

Incidentally, in this type of video processing technology, a virtual object generated based on a marker disappears when the marker falls out of a camera frame, and hence an interaction between the virtual object and a user is impaired.

When the interaction between the virtual object and the user is impaired, interest of the user is lost. Accordingly, it is desired to take measures to prevent the virtual object from suddenly disappearing.

Meanwhile, when a plurality of users can share an augmented reality space in which virtual objects are arranged, interactions using the virtual objects can be achieved among the plurality of users.

The present invention has been made in view of the above-mentioned circumstances, and has an object to provide a video processing system capable of improving interest of a user.

### Solution to Problem

In order to achieve the above-mentioned object, according to one embodiment of the present invention, there is provided a video processing system for generating an augmented reality space based on a video of a real space, the video processing system including: a plurality of user terminals each owned by one of a plurality of users and each configured to generate first space data based on the video of the real space acquired in real time; and a server to be accessed by the plurality of user terminals, which is configured to store second space data generated based on an image of the real space acquired in advance, wherein the video processing system is configured to execute: a positional information acquisition step of acquiring positional information on the plurality of user terminals in the real space by comparing the first space data and the second space data to each other; and an augmented reality space generation step of generating the augmented reality space by arranging a virtual object in the video of the real space acquired in real time based on the positional information acquired in the positional information acquisition step.

According to the above-mentioned configuration, the augmented reality space is generated based on the positional information acquired by comparing the first space data and the second space data to each other, and hence interactions between the virtual object and the plurality of users, which are achieved through the user terminals, are not impaired as long as the positional information continues to be acquired.

In addition, the plurality of users can share the augmented reality space in which virtual objects are arranged through the user terminals, and hence interactions using the virtual objects can be achieved among the plurality of users.

Accordingly, it is possible to improve the interest of the users.

In the video processing system, the first space data is generated through extraction of feature amounts of the video of the real space, the second space data is generated through extraction of feature amounts of the image of the real space, and the positional information acquisition step includes acquiring the positional information on the plurality of user terminals when each of the feature amounts of the video of the real space in the first space data and a corresponding one of the feature amounts of the image of the real space in the second space data match each other.

Further, in the video processing system, the server may be configured to execute the positional information acquisition step, and the second space data may be compressed at a time of storing the second space data into the server when a size of the second space data exceeds a threshold value suitably set in advance.

In the video processing system, a frequency of comparing the first space data and the second space data to each other in the positional information acquisition step is adjusted based on a frequency at which each of the plurality of user terminals accesses the server.

Incidentally, the server of the video processing system may be implemented in a cloud environment.

In order to achieve the above-mentioned object, according to one embodiment of the present invention, there is provided a video processing method using a video processing system, the video processing system including: a plurality of user terminals each owned by one of a plurality of users and each configured to generate first space data based on a video of a real space acquired in real time; and a server to be accessed by the plurality of user terminals, which is configured to store second space data generated based on an image of the real space acquired in advance, the video processing method including: executing a positional information acquisition step of acquiring positional information on the plurality of user terminals in the real space by comparing the first space data and the second space data to each other; and executing an augmented reality space generation step of generating an augmented reality space by arranging a virtual object in the video of the real space acquired in real time based on the positional information acquired in the positional information acquisition step.

### Advantageous Effects of Invention

According to the present invention, the interest of the user can be improved.

### BRIEF DESCRIPTION OF DRAWINGS

FIG. 1 is a diagram for illustrating an outline of a configuration of a video processing system according to an embodiment of the present invention.

FIG. 2 is a block diagram for illustrating an outline of a configuration of a user terminal of the video processing system according to this embodiment.

FIG. 3 is a block diagram for illustrating an outline of a configuration of a terminal-side video processing program stored in the user terminal of the video processing system according to this embodiment.

FIG. 4A is a view for illustrating an outline of processing performed by the user terminal of the video processing system according to this embodiment.

FIG. 4B is a view for illustrating an outline of processing performed by the user terminal of the video processing system according to this embodiment.

FIG. 5 is a block diagram for illustrating an outline of a configuration of a cloud server of the video processing system according to this embodiment.

FIG. 6 is a block diagram for illustrating an outline of a configuration of a storage of the cloud server of the video processing system according to this embodiment.

FIG. 7A is a view for illustrating an outline of second space data processed by the video processing system according to this embodiment.

FIG. 7B is a view for illustrating an outline of second space data processed by the video processing system according to this embodiment.

FIG. 8 is a table for showing an outline of virtual object data processed by the video processing system according to this embodiment.

FIG. 9 is a view for illustrating an outline of processing of a positional information acquisition step performed by a positional information acquisition module of the video processing program of the video processing system according to this embodiment.

FIG. 10 is a block diagram for illustrating an outline of structure of positional information processed by the video processing system according to this embodiment.

FIG. 11 is a view for illustrating an example of an augmented reality space generated by the video processing system according to this embodiment.

### DESCRIPTION OF EMBODIMENTS

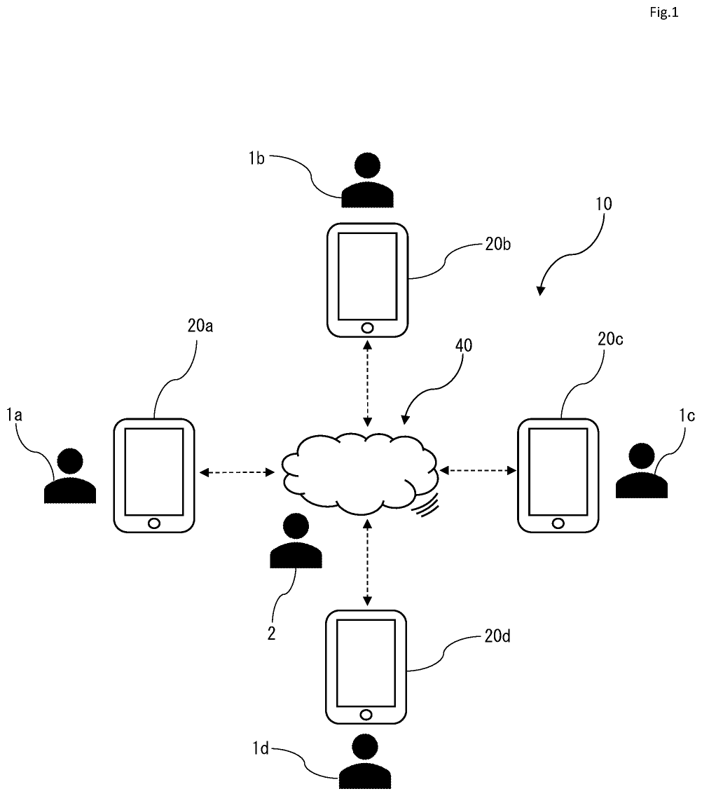

Now, referring to FIG. 1 to FIG. 11, a video processing system according to an embodiment of the present invention is described.

FIG. 1 is a diagram for illustrating an outline of a configuration of the video processing system according to this embodiment. As illustrated in FIG. 1, a video processing system 10 includes, as main components, a plurality of user terminals 20a to 20d and a cloud server 40 serving as a server, and those components are accessibly connected to one another through a network such as the Internet.

In this embodiment, the user terminals 20a to 20d are owned by users 1a to 1d, respectively, who use a service using the video processing system 10, which is provided by a service provider 2 described later, and the cloud server 40 is managed by the service provider 2 that provides the service using the video processing system 10.

In this embodiment, the user terminals 20a to 20d are each implemented by a smartphone or a tablet computer, which is a mobile information terminal.

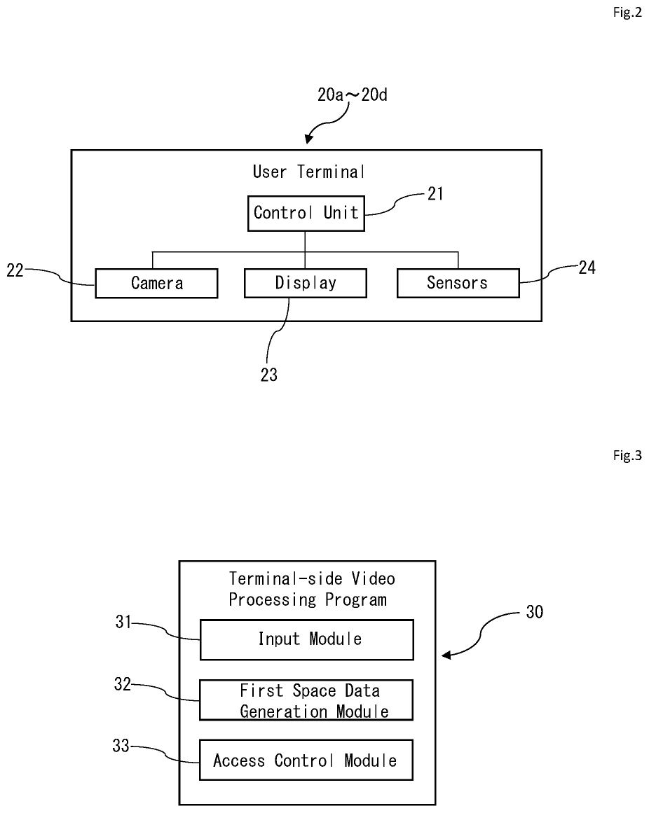

FIG. 2 is a block diagram for illustrating an outline of a configuration of each of the user terminals 20a to 20d. As illustrated in FIG. 2, the user terminals 20a to 20d each include, as main components, a control unit 21, a camera 22, a display 23, and sensors 24.

The control unit 21 controls the camera 22, the display 23, the sensors 24, and other units of each of the user terminal 20a to a user terminal 20d, and is formed of, for example, a processor, a memory, a storage, and a transmission/reception unit. In this embodiment, the control unit 21 stores a terminal-side video processing program.

FIG. 3 is block diagram for illustrating an outline of a configuration of the terminal-side video processing program. As illustrated in FIG. 3, a terminal-side video processing program 30 includes an input module 31, a first space data generation module 32, and an access control module 33.

The input module 31 is a module for receiving various kinds of information input to each of the user terminals 20a to 20d, and receives, in this embodiment, a video and an image acquired by the camera 22.

The first space data generation module 32 is a module for processing the video and the like received by the input module 31. In this embodiment, the first space data generation module 32 processes a video of a real space acquired in real time by the camera 22 and received by the input module 31.

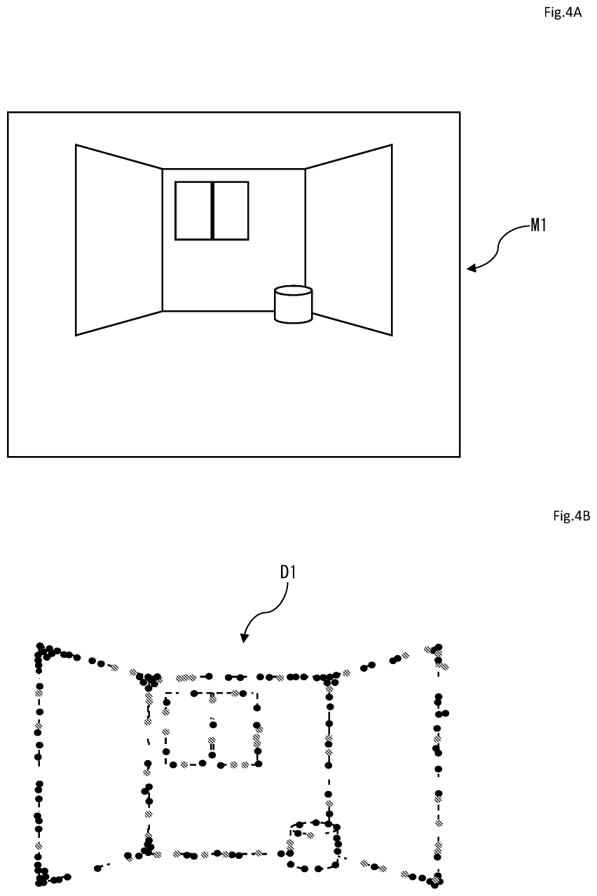

FIGS. 4A and 4B are views for illustrating an outline of processing performed by the first space data generation module 32. In this embodiment, the first space data generation module 32 extracts, as illustrated in FIG. 4B, feature amounts of pixel information on a video M1 of the real space from the video M1 of the real space acquired in real time by the camera 22 as illustrated in FIG. 4A, and generates first space data D1 based on the extracted feature amounts.

In this embodiment, the video M1 is formed of a location video of a real space, for example, a downtown or a facility in a freely-selected region.

The access control module 33 illustrated in FIG. 3 is a module for controlling the access of each of the user terminals 20a to 20d to the cloud server 40, and in this embodiment, for example, when the video M1 of the real space acquired in real time by the camera 22 does not greatly change over a certain period of time, the access control module 33 lowers a frequency at which each of the user terminals 20a to 20d accesses the cloud server 40.

The camera 22 illustrated in FIG. 2 captures any freely-selected thing as a subject to acquire the resultant as a video or an image, and in this embodiment, acquires the video M1 of the real space illustrated in FIG. 4(a) in real time.

On the display 23, the video or image acquired by the camera 22, an interface of an application program stored in each of the user terminals 20a to 20d, and the like are displayed, and in this embodiment, the video M1 of the real space and a video M2 of an augmented reality space, which is described later, are displayed.

In this embodiment, the display 23 receives input of information through a touch on a display surface, and is implemented by any of various kinds of technologies, such as a resistive film system and a capacitive system.

In this embodiment, the sensors 24 are formed of a gyroscope, an acceleration sensor, and the like, and detects a position and a direction of each of the user terminals 20a to 20d in the real space.

In this embodiment, the cloud server 40 illustrated in FIG. 1 is implemented by, for example, a desktop or laptop computer.

FIG. 5 is a block diagram for illustrating an outline of a configuration of the cloud server 40. As illustrated in FIG. 5, the cloud server 40 includes, as main components, a processor 41, a memory 42, a storage 43, a transmission/reception unit 44, and an input/output unit 45, and those components are electrically connected to one another through a bus 46.

The processor 41 is an arithmetic device for controlling an operation of the cloud server 40 to perform, for example, control of transmission and reception of data between elements and processing required for executing an application program.

In this embodiment, the processor 41 is, for example, a central processing unit (CPU), and performs each kind of processing by executing an application program stored in the storage 43 and loaded into the memory 42, each of which is described later.

The memory 42 includes a main storage device formed of a volatile storage device such as a dynamic random access memory (DRAM) and an auxiliary storage device formed of a nonvolatile storage device, such as a flash memory or a hard disk drive (HDD).

The memory 42 is used as a work area for the processor 41, and also stores a basic input/output system (BIOS) to be executed at a startup of a computer, various kinds of setting information, and the like.

The storage 43 stores an application program, data to be used for various kinds of processing, and the like.

The transmission/reception unit 44 connects the cloud server 40 to the network. The transmission/reception unit 44 may include a short-range communication interface, such as Bluetooth (trademark) or Bluetooth Low Energy (BLE).

The input/output unit 45 is connected to an information input device, such as a keyboard or a mouse, and an output device such as a display as the requirement arises. In this embodiment, the input/output unit 45 is connected to a keyboard, a mouse, and a display.

The bus 46 transmits, for example, an address signal, a data signal, and various kinds of control signals among the processor 41, the memory 42, the storage 43, the transmission/reception unit 44, and the input/output unit 45, which are connected to the bus 46.

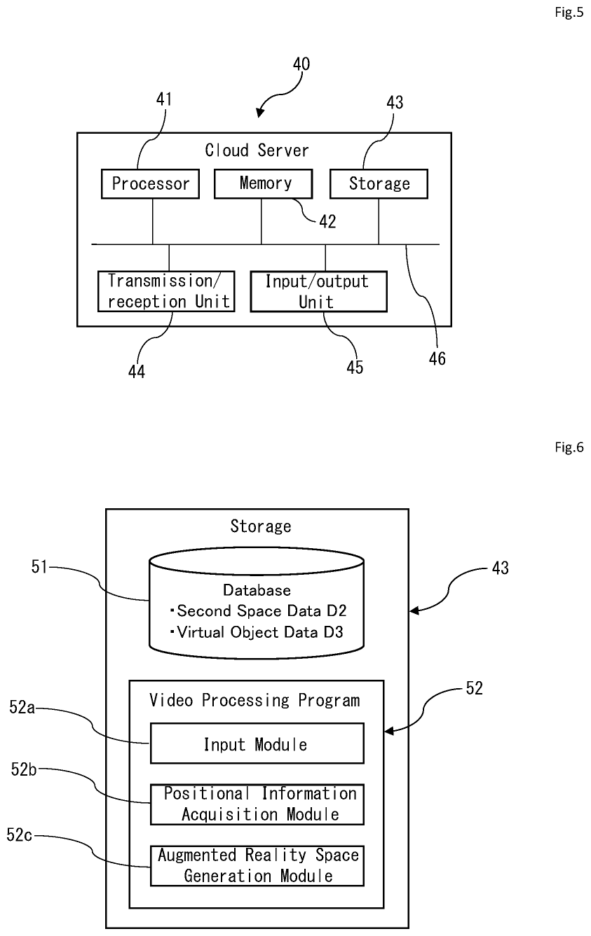

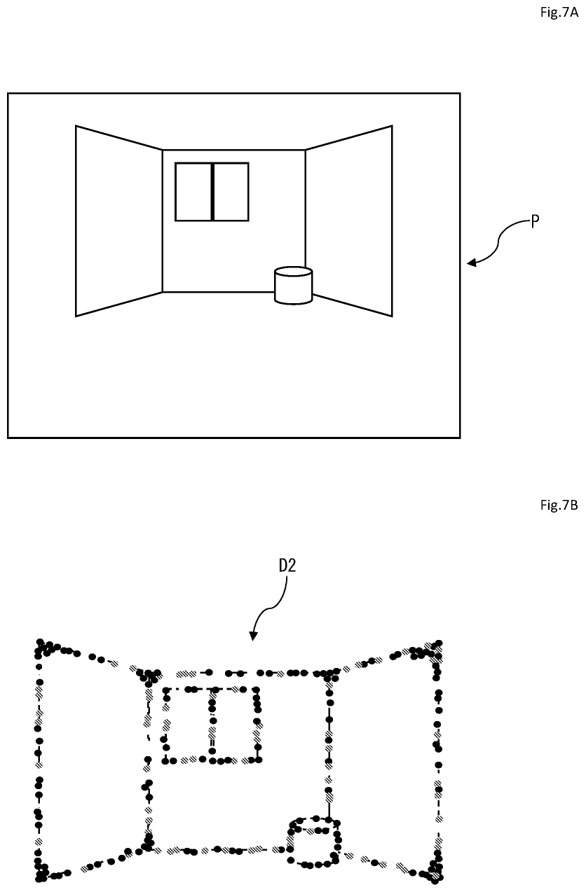

FIG. 6 is a block diagram for illustrating an outline of a configuration of the storage 43 of the cloud server 40. As illustrated in FIG. 6, the storage 43 includes a database 51 implemented by a storage area of the storage 43 and a video processing program 52.

In this embodiment, the database 51 stores second space data D2 and virtual object data D3, which have been generated based on an image of a real space acquired in advance.

In this embodiment, a maximum size of one piece of second space data D2 to be stored is set as a threshold value in advance for the database 51.

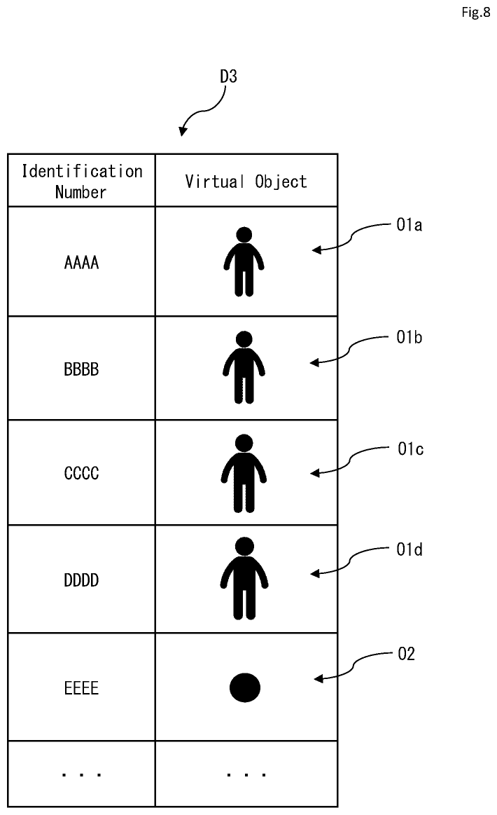

FIGS. 7A and 7B are views for illustrating an outline of the second space data D2. In this embodiment, feature amounts of pixel information on an image P of a real space acquired in advance as illustrated in FIG. 7A are extracted as illustrated in FIG. 7B, and the second space data D2 is generated based on the extracted feature amounts.

In this embodiment, the image P is formed of a location image of a real space, for example, a downtown or a facility in a freely-selected region, which has been acquired in advance by one of the users 1a to 1d, the service provider 2, or the like.

In this embodiment, a map of the region in which the location image forming the image P has been acquired is formed based on the image P.

In this embodiment, when the size of the second space data D2 exceeds the threshold value set in advance for the database 51, the second space data D2 is compressed by, for example, having a resolution thereof lowered or an unrequired portion thereof removed at a time of being stored into the database 51 of the storage 43 of the cloud server 40.

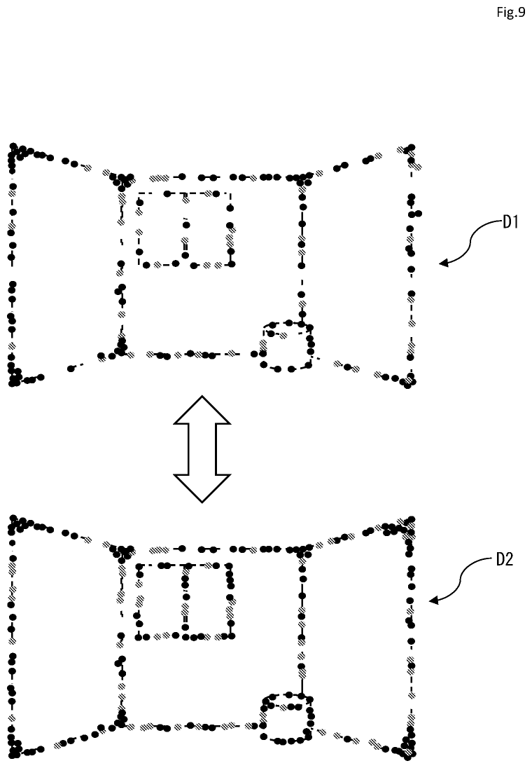

FIG. 8 is a table for showing an outline of the virtual object data D3. As shown in FIG. 8, in this embodiment, the virtual object data D3 is formed of a plurality of human-shaped virtual objects O1a to O1d, a soccer-ball-shaped virtual object O2, and the like to each of which an identification number is assigned, and each object is associated with suitable coordinates in the map formed of the image P based on the identification number.

The video processing program 52 illustrated in FIG. 6 includes an input module 52a, a positional information acquisition module 52b, and an augmented reality space generation module 52c.

In this embodiment, the input module 52a is a module for receiving pieces of first space data D1 generated by the user terminals 20a to 20d.

The positional information acquisition module 52b is a module for executing a positional information acquisition step of acquiring positional information relating to positions at which the user terminals 20a to 20d are present in the real space.

FIG. 9 is a view for illustrating an outline of processing of the positional information acquisition step performed by the positional information acquisition module 52b. As illustrated in FIG. 9, in the positional information acquisition step, the first space data D1 and the second space data D2 are first compared to each other to determine whether or not each of the feature amounts of the video M1 of the real space in the first space data D1 and a corresponding one of the feature amounts of the image P of the real space in the second space data D2 match each other.

When it is determined that the feature amounts match each other, the positional information relating to the positions at which the user terminals 20a to 20d are present in the real space, orientations of the user terminals 20a to 20d, and the like is acquired.

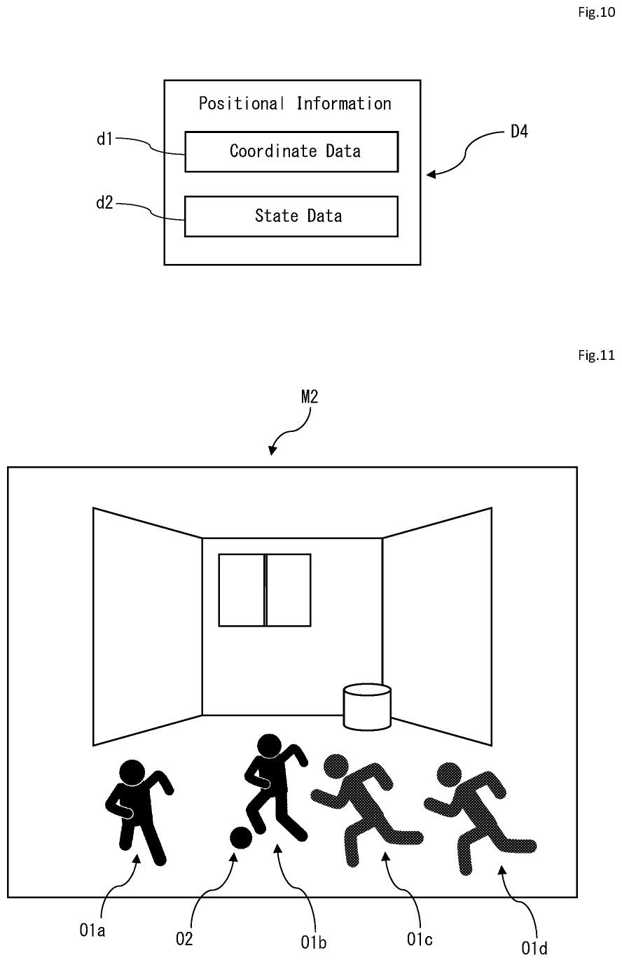

FIG. 10 is a block diagram for illustrating an outline of structure of the positional information. As illustrated in FIG. 10, in this embodiment, positional information D4 is formed of coordinate data d1 relating to the positions at which the user terminals 20a to 20d are present in terms of coordinates, which are grasped based on the coordinates in the map formed of the image P, and state data d2 relating to the positions and orientations of the user terminals 20a to 20d acquired by the sensors 24 of the user terminals 20a to 20d.

The augmented reality space generation module 52c illustrated in FIG. 6 is a module for executing an augmented reality space generation step of generating an augmented reality space by arranging suitable virtual objects in the video M1 of the real space, which has been acquired in real time by the camera 22 of each of the user terminals 20a to 20d, based on the positional information D4 acquired in the positional information acquisition step.

In the augmented reality space generation step, when the coordinate data d1 of the positional information D4 acquired in relation to the user terminals 20a to 20d matches the coordinates in the map formed of the image P, which are associated with the virtual objects, the virtual objects are arranged in the video M1 of the real space acquired in real time in accordance with the positions and directions of the user terminals 20a to 20d based on the state data d2 of the positional information D4.

Thus, the augmented reality space is generated on the display 23 of each of the user terminals 20a to 20d.

FIG. 11 is a view for illustrating an example of the augmented reality space generated in the augmented reality space generation step.

As illustrated in FIG. 11, in the augmented reality space generation step, for example, the human-shaped virtual objects O1a to O1d and the soccer-ball-shaped virtual object O2 are arranged in the video M1 of the real space acquired in real time by each of the user terminals 20a to 20d owned by the users 1a to 1d, respectively, on which the positional information D4 has been acquired, and the augmented reality space M2 is thus generated on the display 23 of each of the user terminals 20a to 20d.

Next, an operation of the video processing system 10 according to this embodiment is described.

This embodiment is described by taking an exemplary case in which the four users 1a to 1d in the real space being a facility in a freely-selected region use the video processing system 10 to play a soccer game in the augmented reality space M2 generated on the user terminals 20a to 20d.

First, the users 1a to 1d activate the terminal-side video processing program 30 on the user terminals 20a to 20d owned by the users 1a to 1d, respectively, and acquire the video M1 of the real space in real time by the cameras 22 of the user terminals 20a to 20d.

In this embodiment, the user terminals 20a to 20d generate the first space data D1 by extracting the feature amounts from the video M1 of the real space acquired in real time.

Meanwhile, the user terminals 20a to 20d each access the cloud server 40 and compare the first space data D1 and the second space data D2 to each other to determine whether or not each of the feature amounts of the video M1 of the real space in the first space data D1 and a corresponding one of the feature amounts of the image P of the real space in the second space data D2 match each other.

When it is determined that the feature amounts match each other, pieces of the positional information D4 relating to the user terminals 20a to 20d are acquired (positional information acquisition step).

At this time, in this embodiment, when the video M1 of the real space acquired in real time by the camera 22 of each of the user terminals 20a to 20d does not greatly change over a certain period of time, the frequency at which each of the user terminals 20a to 20d accesses the cloud server 40 is lowered.

Thus, a frequency of comparing the first space data D1 and the second space data D2 to each other is adjusted so as to be lowered, and hence work of arithmetic operation processing performed by the cloud server 40 at a time of comparison is reduced, thereby achieving speed-up of the arithmetic operation processing.

Meanwhile, in a case in which the coordinate data d1 of the positional information D4 obtained when the video M1 of the real space is acquired in real time by the user terminals 20a to 20d matches the coordinates in the map, which are associated with the virtual objects O1a to O1d and O2, the virtual objects O1a to O1d and O2 are arranged in the video M1 of the real space acquired in real time based on the state data d2 of the positional information D4, and the augmented reality space M2 is generated on the display 23 of each of the user terminals 20a to 20d (augmented reality space generation step).

In the augmented reality space M2 exemplified in FIG. 11, the virtual objects O1a to O1d and the virtual object O2 are arranged in the video M1 of the real space acquired in real time by each of the user terminals 20a to 20d owned by the users 1a to 1d, respectively.

In this embodiment, for example, the user 1a uses the user terminal 20a to operate the virtual object O1a, the user 1b uses the user terminal 20b to operate the virtual object O1b, the user 1c uses the user terminal 20c to operate the virtual object Olc, and the user 1d uses the user terminal 20d to operate the virtual object O1d.

Thus, the users 1a to 1d can play the soccer game in the augmented reality space M2 generated on the user terminals 20a to 20d through use of the soccer-ball-shaped virtual object O2.

In this manner, the augmented reality space M2 is generated based on the positional information D4 acquired by comparing the first space data D1 and the second space data D2 to each other, and hence interactions between the virtual objects O1a to O1d and virtual object O2 and the plurality of users 1a to 1d, which are achieved through the user terminals 20a to 20d, are not impaired as long as the positional information D4 continues to be acquired.

In addition, in this embodiment, the plurality of users 1a to 1d can share the augmented reality space M2 in which the virtual objects O1a to O1d and the virtual object O2 are arranged through the user terminals 20a to 20d, and hence interactions using the virtual objects O1a to O1d and the virtual object O2 can be achieved among the plurality of users 1a to 1d.

Accordingly, it is possible to improve interest of the users.

The present invention is not limited to the above-mentioned embodiment, and various changes can be made thereto within the scope that does not depart from the gist of the invention.

The above-mentioned embodiment has been described by taking the case in which the first space data D1 is generated through extraction of the feature amounts from the video M1 of the real space acquired in real time and the second space data D2 is generated through extraction of the feature amounts of the pixel information on the image P of the real space acquired in advance, but the generation thereof does not require the extraction of feature amounts.

For example, the first space data D1 may be generated by lowering a resolution of each frame forming the video M1, and the second space data D2 may be generated by lowering a resolution of the image P.

The above-mentioned embodiment has been described by taking the case in which the four user terminals 20a to 20d share the augmented reality space M2, but it is to be understood that the number of user terminals can be increased or decreased as appropriate.

The above-mentioned embodiment has been described by taking the case in which the users 1a to 1d play the soccer game in the augmented reality space M2 generated on the user terminals 20a to 20d, but the present invention can be applied to various kinds of content, such as other action games, adventure games, role-playing games, and live performances of virtual characters.

In such cases, it is to be understood that different kinds of virtual objects can be employed depending on the content.

In addition, the present invention can be applied to various purposes, such as customer guidance in large-scale stores, outdoor advertising, and work management at work sites.

The above-mentioned embodiment has been described by taking the case in which the server is the cloud server 40 managed by the service provider 2, but the server may be a server located at the service provider 2.

### REFERENCE SIGNS LIST

1a to 1d user
10 video processing system
20a to 20d user terminal
30 terminal-side video processing program
32 first space data generation module
33 access control module
40 cloud server (server)
51 database
52 video processing program
52b positional information acquisition module
52c augmented reality space generation module
D1 first space data
D2 second space data
D3 virtual object data
D4 positional information
M1 video
M2 augmented reality space
O1a to O1d, O2 virtual object
P image

1. A video processing system for generating an augmented reality space based on a video of a real space, the video processing system comprising:
a plurality of user terminals each owned by one of a plurality of users and each configured to generate first space data based on the video of the real space acquired in real time; and
a server to be accessed by the plurality of user terminals, which is configured to store second space data generated based on an image of the real space acquired in advance,
wherein the video processing system is configured to execute:
a positional information acquisition step of acquiring positional information on the plurality of user terminals in the real space by comparing the first space data and the second space data to each other; and
an augmented reality space generation step of generating the augmented reality space by arranging a virtual object in the video of the real space acquired in real time based on the positional information acquired in the positional information acquisition step.

2. The video processing system according to claim 1,
wherein the first space data is generated through extraction of feature amounts of the video of the real space,
wherein the second space data is generated through extraction of feature amounts of the image of the real space, and
wherein the positional information acquisition step includes acquiring the positional information on the plurality of user terminals when each of the feature amounts of the video of the real space in the first space data and a corresponding one of the feature amounts of the image of the real space in the second space data match each other.

3. The video processing system according to wherein the server is configured to execute the positional information acquisition step.

4. The video processing system according to claim 1, wherein the second space data is compressed at a time of storing the second space data into the server when a size of the second space data exceeds a threshold value suitably set in advance.

5. The video processing system according to claim 1, wherein a frequency of comparing the first space data and the second space data to each other in the positional information acquisition step is adjusted based on a frequency at which each of the plurality of user terminals accesses the server.

6. The video processing system according to claim 1, wherein the server is implemented in a cloud environment.

7. A video processing method using a video processing system,
the video processing system including:
a plurality of user terminals each owned by one of a plurality of users and each configured to generate first space data based on a video of a real space acquired in real time; and
a server to be accessed by the plurality of user terminals,
which is configured to store second space data generated based on an image of the real space acquired in advance,
the video processing method comprising:
executing a positional information acquisition step of acquiring positional information on the plurality of user terminals in the real space by comparing the first space data and the second space data to each other; and
executing an augmented reality space generation step of generating an augmented reality space by arranging a virtual object in the video of the real space acquired in real time based on the positional information acquired in the positional information acquisition step.
